(19) United States
(12) Patent Application Publication
(10) Pub. No.: US 2009/0154868 A1
(43) Pub. Date: Jun. 18, 2009

(54) SEMICONDUCTOR OPTO-ELECTRONIC INTEGRATED CIRCUITS AND METHODS OF FORMING THE SAME

(75) Inventors: Mi-Ran PARK, Daejeon (KR); O-Kyun Kwon, Daejeon (KR); Jeong-Woo Park, Daejeon (KR); Gyung-Ock Kim, Seoul (KR)

Correspondence Address: AMPACC LAW GROUP, 13024 Beverly Park Road, Suite 205, Mukilteo, WA, 98275, US

(73) Assignee: Electronics and Telecommunications Research Institute, Daejeon (KR)

(21) Appl. No.: 12/117,707

(22) Filed: May 8, 2008

(30) Foreign Application Priority Data
Dec. 17, 2007 (KR) 10-2007-0132339

(51) Int. Cl. G02F 1/295

(52) U.S. Cl. 385/8

(57) ABSTRACT

Provided are semiconductor opto-electronic integrated circuits and methods of forming the same. The semiconductor opto-electronic integrated circuit includes: an optical waveguide disposed on a substrate and including an input terminal and an output terminal; an optical grating formed on the optical waveguide; and an optical active device disposed on the optical grating and receiving an optical signal from the optical waveguide through the optical grating to modulate the optical signal.

### CROSS-REFERENCE TO RELATED APPLICATIONS

This U.S. non-provisional patent application claims priority under 35 U.S.C. § 119 of Korean Patent Application No. 10-2007-0132339, filed on Dec. 17, 2007, the entire contents of which are hereby incorporated by reference.

### BACKGROUND OF THE INVENTION

The present invention disclosed herein relates to a semiconductor integrated circuit and a method of forming the same, and more particularly, to a semiconductor opto-electronic integrated circuit that includes an optical active device modulating an optical signal and a method of forming the same.

The present invention has been derived from a research undertaken as a part of the information technology (IT) R & D program of the Ministry of Information and Communication and Institution for Information Technology Association (MIC/IITA) [2006-S-004-02], Project title: silicon-based high speed optical interconnection IC.

Recently, as a semiconductor industry has been highly developed, a semiconductor integrated circuit becomes faster, lighter and/or more highly integrated. These semiconductor opto-electronic integrated circuits are connected to each other by mainly using electrical signals. However, because internal devices of semiconductor integrated circuits or semiconductor integrated circuits are connected to each other through electrical wirings, transmission speeds of signals between them may reach limitations.

To resolve the limitations, research for optical communication and/or optical interconnection as one program is aggressively under development. That is, actively undertaken is research for replacing signals with optical signals between semiconductor integrated circuits, semiconductor integrated circuits and other electronic medium, or internal devices in semiconductor integrated circuits.

For optical communication and/or optical interconnection, changing of characteristics of an optical signal is required. A semiconductor that is mainly used for a semiconductor opto-electronic integrated circuit is silicon. Accordingly, suggested is a plan of fabricating an active device for optical communication and/or optical interconnection by means of silicon. However, silicon has very poor optical characteristics. Therefore, various limitations may occur during the fabricating of the active device. For example, due to poor optical characteristics of silicon, characteristics of a silicon semiconductor optical integrated circuit may be deteriorated, and also because the size of a silicon active device for optical communication and/or optical interconnection increases, the high degree of integration may not be achieved in a semiconductor opto-electronic integrated circuit. Furthermore, power consumption of a semiconductor opto-electronic integrated circuit may increase.

### SUMMARY OF THE INVENTION

The present invention provides a semiconductor opto-electronic integrated circuit optimized for optical communication and/or optical interconnection, and a method of forming the same.

The present invention also provides a semiconductor opto-electronic integrated circuit optimized for the high degree of integration, and a method of forming the same.

The present invention also provides a semiconductor opto-electronic integrated circuit optimized for low power consumption and high speed, and a method of forming the same.

Embodiments of the present invention provide semiconductor opto-electronic integrated circuits including: an optical waveguide disposed on a substrate and including an input terminal and an output terminal; an optical grating formed on the optical waveguide; and an optical active device disposed on the optical grating and receiving an optical signal from the optical waveguide through the optical grating to modulate the optical signal.

In some embodiments, the semiconductor opto-electronic integrated circuits may further include an adhesive layer interposed between the optical active device and the optical grating, the optical active device being mounted on the optical grating through the adhesive layer.

In other embodiments, the semiconductor opto-electronic integrated circuit may further include: a chip substrate on which the optical active device is mounted; and a chip bonding bumper interposed between the chip substrate and the substrate. The optical active device is interposed between the chip substrate and the substrate to be disposed on the optical grating.

In still other embodiments, the optical active device may absorb or do not absorb an optical signal inputted from the optical waveguide by controlling an electric field, and also outputs the non-absorbed optical signal to the optical waveguide through the optical grating.

In even other embodiments, the optical active device may modulate a phase of an optical signal inputted from the optical waveguide, and outputs the modulated optical signal to the optical waveguide through the optical grating.

In yet other embodiments, the optical active device may include: a first reflective layer adjacent to the optical grating; a second reflective layer disposed on the first reflective layer and having a higher reflectivity than the first reflective layer; and an optical active layer interposed between the first and second reflective layers and disposed above the optical grating.

In further embodiments, the first reflective layer, the optical active layer, and the second reflective layer may be formed of III-V compound semiconductor.

In still further embodiments, one of the first and second reflective layers may be doped with an n-type dopant and the other may be doped with a p-type dopant.

In even further embodiments, the optical active layer may be formed of a multi quantum well layer.

In yet further embodiments, the optical active layer may be in an intrinsic state.

In yet further embodiments, a plurality of the optical waveguides may be disposed on the substrate. In this case, a plurality of the optical gratings may be respectively disposed on the optical waveguides, and a plurality of the optical active devices may be respectively disposed on the optical gratings. The semiconductor opto-electronic integrated circuits may further include: a demultiplexer including one input path and a plurality of output paths connected to input terminals of the optical waveguides, respectively; and a multiplexer including one output path and a plurality of input paths connected to output terminals of the optical waveguides, respectively.

In other embodiments of the present invention, methods of forming a semiconductor opto-electronic integrated circuit include: forming an optical waveguide on a substrate and an optical grating on an optical waveguide; forming an optical active device that modulates an optical signal inputted form the optical waveguide; and disposing the optical active device on the optical grating.

In some embodiments, the disposing of the optical active device on the optical grating may include: activating one side of the optical active device; activating the top surface of the substrate including the surfaces of the optical waveguide and the optical grating; and bonding the activated side of the optical active device with the activated side of the substrate.

In other embodiments, the disposing of the optical active device on the optical grating may include: mounting the optical active device on the optical grating; and flip-chip bonding a chip substrate having the optical active device on the substrate through a chip bonding bumper.

In still other embodiments, the forming of the optical active device may include: forming an optical active layer on a first reflective layer; and forming a second reflective layer on the optical active layer, the second reflective layer having a higher reflectivity than the first reflective layer. The disposing of the optical active device on the optical grating includes: sequentially stacking the first reflective layer, the optical active layer, and the second reflective layer on the optical grating.

In even other embodiments, the first reflective layer, the optical active layer, and the second reflective layer may be formed of III-V compound semiconductor.

In yet other embodiments, one of the first and second reflective layers may be doped with an n-type dopant and the other may be doped with a p-type dopant.

According to the present invention, an optical active device is disposed on an optical grating above a waveguide. Accordingly, a highly integrated semiconductor opto-electronic integrated circuit can be realized. Additionally, the optical active device is formed and then disposed on the optical grating. Therefore, the optical active device can be additionally formed as a material having excellent optical characteristic, and also the optical waveguide can be formed in the semiconductor opto-electronic integrated circuit. Consequently, the semiconductor opto-electronic integrated circuit optimized for optical communication and/or optical interconnection can be realized.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a plan view of a semiconductor opto-electronic integrated circuit according to one embodiment of the present invention;

FIG. 2 is a sectional view taken along line I-I′ of FIG. 1;

FIG. 3 is a sectional view of a modified optical active device of FIG. 2;

FIG. 4 is a plan view of a modified semiconductor opto-electronic integrated circuit of FIG. 1;

FIG. 5 is a flowchart illustrating a method of forming a semiconductor opto-electronic integrated circuit according to one embodiment of the present invention;

FIG. 6 is a plan view of a semiconductor opto-electronic integrated circuit according to another embodiment of the present invention;

FIG. 7 is a sectional view taken along line II-II′ of FIG. 6;

FIG. 8 is a plan view of a modified semiconductor opto-electronic integrated circuit of FIG. 5; and

FIG. 9 is a flowchart illustrating a method of forming a semiconductor opto-electronic integrated circuit according to another embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. In the figures, the dimensions of layers and regions are exaggerated for clarity of illustration. It will also be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under, and one or more intervening layers may also be present. In addition, it will also be understood that when a layer is referred to as being ‘between’ two layers, it can be the only layer between the two layers, or one or more intervening layers may also be present. Like reference numerals refer to like elements throughout.

### First Embodiment

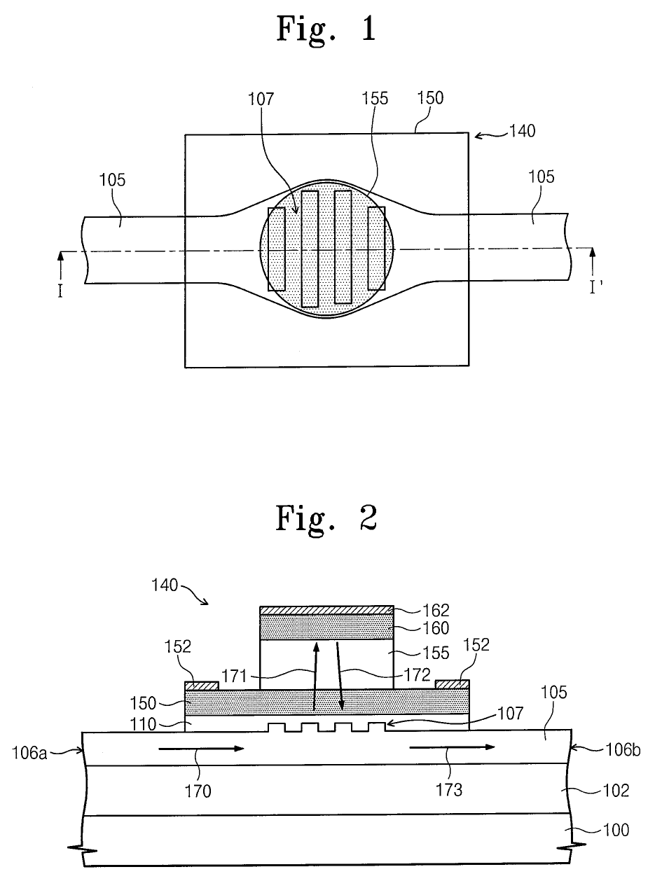

FIG. 1 is a plan view of a semiconductor opto-electronic integrated circuit according to one embodiment of the present invention. FIG. 2 is a sectional view taken along line I-I′ of FIG. 1.

Referring to FIGS. 1 and 2, a cladding layer 102 is disposed on a substrate 100, and an optical waveguide 105 is disposed on the cladding layer 102. The optical waveguide 105 extends along one direction parallel to the top surface of the substrate 100. The optical waveguide 105 includes an input terminal 106a and an output terminal 106b. An optical grating 107 is disposed on a portion of the optical waveguide 105. The optical grating 107 includes a plurality of protrusions that are spaced apart from each other in the one direction. The substrate 100 may be a semiconductor substrate. For example, the substrate 100 may be one of a silicon substrate, a germanium substrate, and a silicon-germanium substrate. The cladding layer 102 may be formed of a material having a different reflectivity than the optical waveguide 105. Additionally, the cladding layer 102 may have a different reflectivity than the substrate 100. For example, the cladding layer 102 may be formed of oxide. The optical waveguide 105 may be formed of semiconductor. For example, the optical waveguide 105 may be formed of one of silicon, germanium, and silicon-germanium. Especially, the substrate 100 and the optical waveguide 105 may be formed of silicon. The protrusions of the optical grating 107 are formed of the same material as the optical waveguide 105. For example, the optical waveguide 105 may be a portion of a silicon layer on a buried oxide layer of a silicon on insulator (SOI) substrate.

An optical active device 140 is disposed on the optical grating 107. The optical active device 140 modulates an optical signal that passes through the optical waveguide 105. In more detail, a first optical signal 170 inputted into the input terminal 106a of the optical waveguide 105 is inputted into the optical active device 140 through the optical grating 107. Characteristic of a second optical signal 171 inputted into the optical active device 140 is modulated in the optical active device 140. A modulated third optical signal 172 is inputted into the optical waveguide 105 through the optical grating 105. A modulated fourth optical signal 173 inputted into the optical waveguide 105 is outputted to the output terminal 106b of the optical waveguide 105.

The optical active device 140 includes an optical active layer 155 disposed over the optical grating 107. Additionally, the optical active device 140 further includes a first reflective layer 150 interposed between the optical active layer 155 and the optical grating 107, and a second reflective layer 160 is disposed on the optical active layer 155. That is, the optical active layer 155 is interposed between the first and second reflective layers 150 and 160.

The second reflective layer 160 has a higher reflectivity than the first reflective layer 150. The first reflective layer 150 of a low reflectivity is adjacent to the optical grating 107, and the second reflective layer of a high reflectivity is spaced far more away from the optical grating 107. Therefore, an incident optical signal via the optical grating 107 passes through the first reflective layer 160, and then is reflected by the second reflective layer 160. The optical signal is asymmetrically resonated by the first and second reflective layers 150 and 160, such that it can return to the optical waveguide 105.

The first reflective layer 150, the optical active layer 155, and the second reflective layer 160 may be formed of III-V group compound semiconductor having an excellent optical characteristic. For example, the first reflective layer 150, the optical active layer 155, and the second reflective layer 160 may include at least one of GaAs, InP, and GaP. One of the first reflective layer 150 and the second reflective layer 160 is doped with an n-type dopant, and the other is doped with a p-type dopant. The optical active layer 155 is in an intrinsic state. Therefore, the first reflective layer 150, the optical active layer 155, and the second reflective layer 160 can constitute a positive intrinsic negative (PIN) diode.

The III-V group compound semiconductor has an excellent optical characteristic. Accordingly, the PIN diode including the first reflective layer 150, the optical active layer 155, and the second reflective layer 160 has a low driving voltage and a fast operating speed. As a result, a semiconductor opto-electronic integrated circuit optimized for optical communication and/or an optical interconnection can be realized. Additionally, the optical active device 140 is disposed on the optical grating 107. Therefore, a highly integrated semiconductor opto-electronic integrated circuit can be realized.

The optical active device 140 can modulate a phase of the inputted optical signal 172. For example, an amount of carriers in the optical active layer 155 can be adjusted by applying predetermined voltages to the first and second electrodes 152 and 162. Accordingly, reflectivity of the optical active layer 155 is changed and thus a phase of the inputted optical signal 172 can be modulated. However, the present invention is not limited to the above. The optical active device 140 can modulate an optical signal in different forms.

The optical active layer 155 and the second reflective layer 160 may have respectively self-aligned sidewalls. The sidewall of the first reflective layer 150 may protrude more compared to the sidewall of the optical active layer 155. That is, the width of the first reflective layer 150 may be broader than that of the optical active layer 155. The first electrode 152 contacts the first reflective layer 150, and the second electrode 162 contacts the second reflective layer 160. The first electrode 152 may contact the edge of the first reflective layer 150 at a side of the optical active layer 155. The second contact 162 can be disposed on an entire top surface of the second reflective layer 160.

The optical active device 140 may be mounted on a portion of the optical grating 107 and the optical waveguide 105 adjacent to the optical grating 107 by using an adhesive layer 110. That is, the adhesive layer 110 is interposed between the optical active device 140 and the optical grating 107. Especially, the adhesive layer 110 interposed between the first reflective layer 150 and the optical grating 107. The adhesive layer 110 may be formed of an oxide.

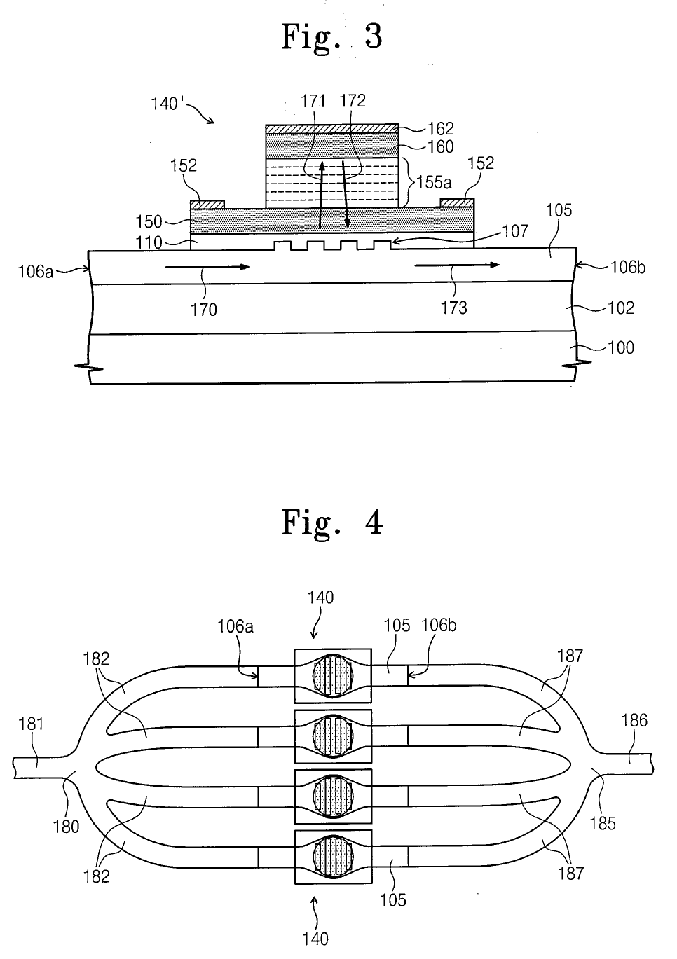

An optical signal of the optical active device 140 can be modulated in another form. This will be described with reference to FIG. 3. Like reference numerals refer to like elements throughout the drawings.

FIG. 3 is a sectional view of a modified optical active device of FIG. 2.

Referring to FIG. 3, an optical active device 140′ is disposed on the optical grating 107. The optical active device 140′ includes a first reflective layer 150 and a second reflective layer 160 and an optical active layer 155a interposed between the first and second reflective layers 150 and 160. The optical active layer 155a may be formed of a multi quantum well layer. Specifically, the optical active layer 155a may include semiconductor layers having respectively different energy band gaps. At this point, the semiconductor layers having respectively different energy band gaps may be formed of a III-V group compound semiconductor. The optical active layer 155a may be in an intrinsic state.

The optical active device 140′ absorbs or does not absorb the inputted optical signal 172 through the optical grating 107 by controlling an electric field. The electric field may generate by a voltage applied through the first and second electrodes 152 and 162. When the optical active device 140′ absorbs the inputted optical signal 172, the optical active device 140′ does not output the optical signal 172 through the optical grating 107. When the optical active device 140′ does not absorb the inputted optical signal 172, the optical active device 140′ outputs the optical signal 172 through the optical grating 107. As a result, the intensity of the optical signal 173 outputted from the optical waveguide 105 becomes different.

Referring to FIGS. 2 and 3, disclosed is that the optical active devices 140 and 140′ can be realized with the optical phase modulator or an optical absorption modulator. However, the present invention is not limited to this. The optical active device of the present invention may modulate an optical signal in different forms unlike FIGS. 2 and 3.

On the other hand, a single optical waveguide is disclosed in FIGS. 1 and 2. Unlike this, a semiconductor opto-electronic integrated circuit includes a plurality of optical waveguides and a plurality of optical active devices. This will be described with reference to the drawings.

FIG. 4 is a plan view of a modified semiconductor opto-electronic integrated circuit of FIG. 1.

Referring to FIG. 4, a plurality of optical waveguides is spaced apart from each other and is disposed on a substrate. The optical waveguides may be disposed on the cladding layer above the substrate as illustrated in FIGS. 1 and 2. A plurality of optical gratings is respectively disposed on the optical waveguides. The optical active devices 140 may be replaced with the optical active devices 140′ of FIG. 2. Unlike this, the optical active devices 140 may be replaced with other optical active devices that modulate signals in different forms. Moreover, the optical active devices disposed on the optical gratings can include the optical active devices of FIGS. 2 and 3 in combination.

A demultiplexer 180 and a multiplexer 185 are disposed on the substrate. The demultiplexer 180 includes one input path 181 and a plurality of output paths 182. The multiplexer 185 includes one output path 186 and a plurality of input paths 187. The output paths 182 of the demultiplexer 180 are respectively connected to the input terminals 106a of the optical waveguide 105, and the input paths 187 of the multiplexer 185 are respectively connected to the output terminals 106b of the optical waveguides 105.

The demultiplexer 180 divides an optical signal inputted through the input path 181 and then transmits the divided signals to the optical waveguide 105. The divided optical signals inputted the optical waveguides 105 may be not modulated or be modulated by the optical active devices 140, and then outputted through the input paths 187 of the multiplexer 185. The multiplexer 185 outputs optical signals inputted through the input paths 187 through the input paths 187.

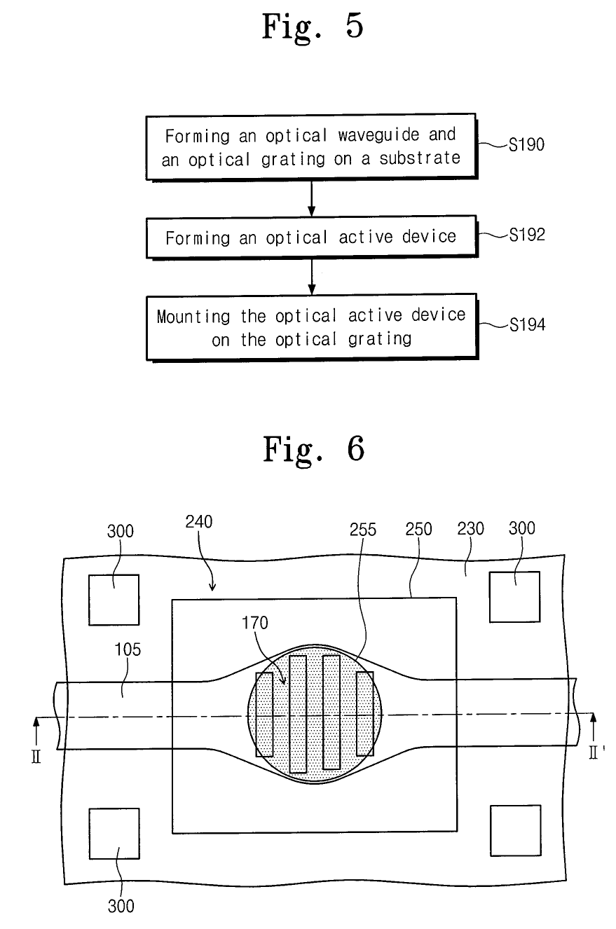

Next, a method of forming a semiconductor opto-electronic integrated circuit according to one embodiment of the present invention will be descried with reference to a flowchart of FIG. 5 and the drawings of FIGS. 1 and 2.

FIG. 5 is a flowchart illustrating a method of forming a semiconductor opto-electronic integrated circuit according to one embodiment of the present invention.

Referring to FIGS. 1, 2, and 5, an optical waveguide 105 and an optical grating 107 on the optical waveguide 105 are formed on a substrate 100 in operation S190. In more detail, prepared is a substrate structure including a substrate 100, a cladding layer 102, and a semiconductor layer, which are sequentially stacked. The substrate 100 may be formed of one of silicon, germanium, and silicon-germanium. The semiconductor layer may be formed of one of silicon, germanium, and silicon-germanium. The semiconductor layer and the substrate 100 may be formed of the same material. For example, the substrate structure may be a SOI substrate. The semiconductor layer is patterned to form the optical waveguide 105 and the optical grating 107. The optical grating 107 is formed on an upper portion of the semiconductor layer, and the semiconductor layer having the optical grating 107 may be patterned to form the optical waveguide 105. On the contrary, after patterning the semiconductor layer to form the optical waveguide 105, an upper portion of the optical waveguide may be patterned to form the optical grating 107.

In operation S192, the optical active device 140 is formed. The optical active device 140 is formed of III-V group compound semiconductor substrate. That is, the first reflective layer 150, the optical active layer 155 or 155a of FIG. 2, and the second reflective layer 160 may be sequentially formed on the III-V group compound semiconductor substrate. The first reflective layer 150 may be a portion of the III-V group compound semiconductor substrate. Next, a structure including the first reflective layer 150, the optical active layer 155, and the second reflective layer 160 is separated from the III-V group compound semiconductor substrate.

The optical active device 140 is mounted on the optical grating 107 in operation S194. In more detail, one side (i.e., the bottom of the first reflective layer 150) of an additionally completed optical active device 140 is activated through an oxygen plasma process. Additionally, one side of the substrate 100 including the top surfaces of the optical grating 107 and the optical waveguide 105 is activated through an oxygen plasma process. At this point, an oxide layer can be formed on the activated side of the optical active device 140. Additionally, an oxide layer can be formed on the activated side of the substrate 100. Next, the activated side of the optical active device 140 and the activated side of the substrate 100 are bonded. At this point, a bonding pressure may be provided to the optical active device 140 and the substrate 100. Additionally, heat treatment can be performed at a predetermined process temperature during the bonding. The bonding may be a wafer bonding. When the activated side of the optical active device 140 and the activated side of the substrate 100 are bonded, the oxide layers at the activated sides of the optical active device 140 and the substrate 100 may be coupled to each other to form the adhesive layer 110 of FIG. 3.

The first and second electrodes 152 and 162 of the optical active device 140 can be formed after mounting the optical active device 140 on the optical grating 107. Unlike this, the first and second electrodes 152 and 162 can be formed before operation S194.

After operation S194, the next processes can be performed on the substrate 100. For example, a process of connecting the optical active device 140 to single devices on the substrate 100, and a process for passivating the substrate 100 can be performed.

### Second Embodiment

One feature of this embodiment is that an optical active device can be mounted on an optical grating in different forms. Like reference numerals refer to like elements throughout the drawings.

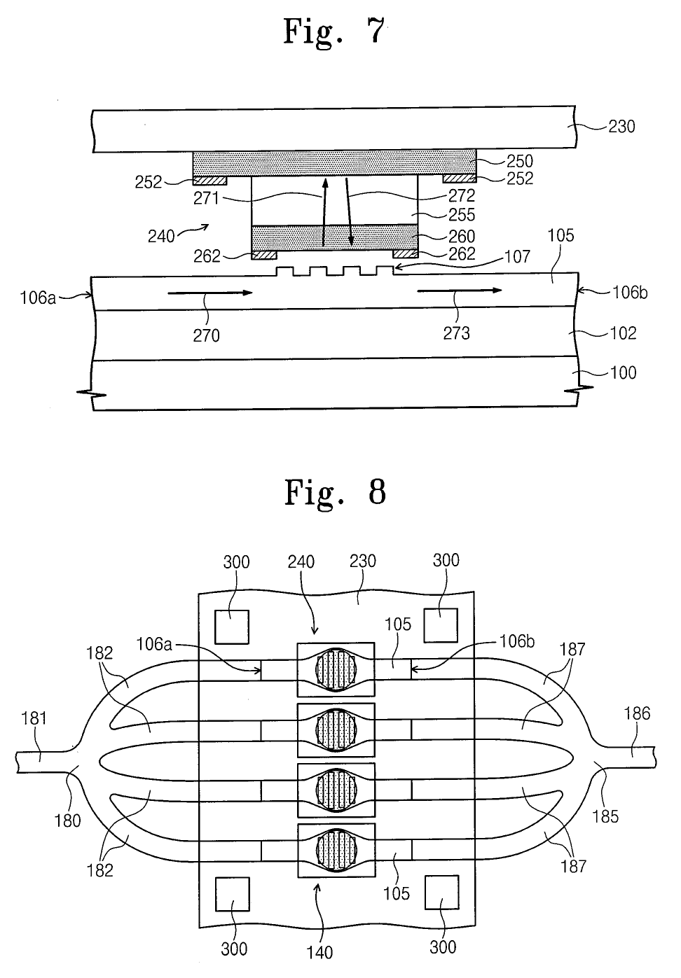

FIG. 6 is a plan view of a semiconductor opto-electronic integrated circuit according to another embodiment of the present invention. FIG. 7 is a sectional view taken along line II-II′ of FIG. 6.

Referring to FIGS. 6 and 7, the optical active device 240 is disposed on the optical grating 107. A chip substrate 230 is disposed on the optical active device 240. The optical active device 240 is mounted on the chip substrate 230. A chip bonding bumper 300 is disposed between the chip substrate 230 and the substrate 100. The chip bonding bumper 300 can connect an external terminal (not shown) of the substrate 100 to an external device (not shown) of the chip substrate 230.

The optical active device 240 includes a first reflective layer 260, an optical active layer 255, and a second reflective layer 250, which are sequentially stacked on the optical grating 107. The second reflective layer 250 contacts and is mounted on the chip substrate 230. The second reflective layer 250 has a higher reflectivity than the first reflective layer 260. The first reflective layer 260 is spaced apart from the optical grating 107.

A first optical signal 270 inputted into the input terminal 106a of the optical waveguide 105 is inputted to the optical active device 240 through the optical grating 107, and a second optical signal 271 inputted to the optical active device 240 is modulated by the optical active device 240. A modulated third optical signal 272 is inputted into the optical waveguide 105 through the optical grating 107, and is outputted through the output terminal 106b of the optical waveguide 105.

The first reflective layer 260 may be formed of the same material as the first reflective layer 150 of FIG. 2. The optical active layer 155 may be formed of the same material as the optical active layer 155 of FIG. 2 or the optical active layer 155a of the FIG. 3. The second reflective layer 250 may be formed of the same material as the second reflective layer 160 of FIG. 2. One of the first and second reflective layers 160 and 150 is doped with an n-type dopant, and the other is doped with a p-type dopant. Accordingly, the optical active device 240 may perform the same functions as the optical active device 140 of FIG. 2 and the optical active device 140′ of FIG. 3. Of course, the optical active device 240 can perform different optical modulations.

The width of the second reflective layer 250 may be greater than those of the first reflective layer 260 and the optical active layer 255. The first electrode 262 is connected to the first reflective layer 260, and the second electrode 252 is connected to the second reflective layer 250. The first electrode 262 may contact the edge of the first reflective layer 260, which is adjacent to the optical grating 107. Therefore, optical signals are inputted or outputted through the center of the first reflective layer 160, which is adjacent to the optical grating 107.

FIG. 8 is a plan view of a modified semiconductor opto-electronic integrated circuit of FIG. 5.

Referring to FIG. 8, a plurality of optical waveguides 105 is disposed on a substrate, and an optical grating 107 is disposed on each of the optical active devices 240. A plurality of optical active devices 240 is disposed on the optical gratings, respectively. A chip substrate 230 is disposed on the substrate, and the optical devices 240 are mounted on one chip substrate 230. The optical active devices 240 are disposed between the chip substrate 230 and the substrate. The optical waveguides 105 are connected to demultiplexer 180 and a multiplexer 185. This was described with reference to FIG. o FIG. 4, and its description will be omitted for conciseness.

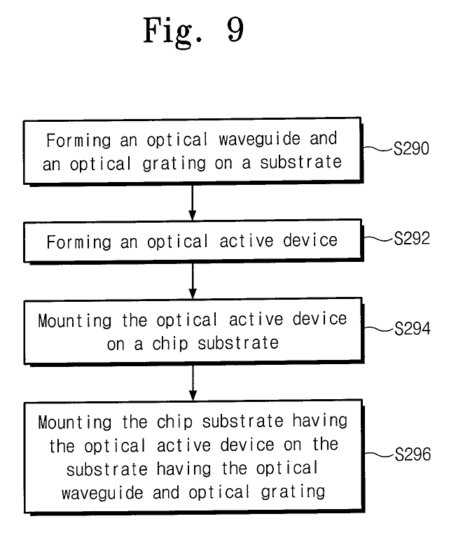

Next, a method of forming a semiconductor opto-electronic integrated circuit according to another embodiment of the present invention will be described with reference to a flowchart of FIG. 9 and the drawings of FIGS. 6 and 7.

FIG. 9 is a flowchart illustrating a method of forming a semiconductor opto-electronic integrated circuit according to another embodiment of the present invention.

Referring to FIGS. 6, 7, and 9, the optical waveguide 105 and the optical grating 107 are formed on the substrate 100 in operation S290. This is identical to operation S190 of FIG. 5.

In operation S292, the optical active device 240 is formed. The optical active device 240 may be formed of a III-V group compound semiconductor substrate. In more detail, the second reflective layer 250, the optical active layer 255, and the first reflective layer 260 are sequentially stacked on the III-V group compound semiconductor substrate. Unlike the first embodiment, the second reflective layer 250 is formed first on the III-V group compound semiconductor substrate. Next, the first electrode 262 connected to the first reflective layer 260 and the second electrode 252 connected to the second reflective layer 250 are formed. After forming the optical active device 240 on the III-V group compound semiconductor substrate, the optical active device 240 is separated from the III-V group compound semiconductor substrate.

Then, the optical active device 240 is mounted on the chip substrate 230 in operation S294. The first and second electrodes 262 and 252 of the optical active device 240 may be connected to external terminals of the chip substrate 230.

Next, the chip substrate 230 having the optical active device 240 is mounted on the substrate 100 having the optical waveguide 105 and the optical grating 107 in operation S296. The chip substrate 230 having the optical active device 240 is flip-chip bonded on the substrate 100 through the chip bonding bumper 300. At this point, the first reflective layer 260 of the optical active device 240 is aligned on the optical grating 107.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A semiconductor opto-electronic integrated circuit comprising:
an optical waveguide disposed on a substrate, the optical waveguide extending along a first direction and having an input terminal and an output terminal, the optical waveguide providing an optical path along the first direction for optical signals traveling from the input terminal to the output terminal;
a cladding layer provided between the optical waveguide and the substrate, the cladding layer being configured to contain the optical signals traveling between the input terminal and the output terminal within the optical waveguide;
an optical grating formed on the optical waveguide on an opposing side of the cladding layer; and
an optical active device having an optical active layer provided between first and second reflective layers, the first reflective layer being disposed on the optical grating and having a lower reflectivity than the second reflective layer,
wherein the first reflective layer is configured to allow a selected optical signal to pass through the first reflective layer and into the optical active layer according to a control signal received by the optical active device.
wherein the optical active layer is configured to modulate the selected optical signal that has passed through the first reflective layer, and
wherein the second reflective layer is configured to reflect the optical signal modulated by the optical active layer to the optical waveguide and be transmitted to the output terminal of the optical waveguide.

2. The semiconductor opto-electronic integrated circuit of claim 1, further comprising an adhesive layer interposed between the optical active device and the optical grating, the optical active device being mounted on the optical grating through the adhesive layer.

3. The semiconductor opto-electronic integrated circuit of claim 1, further comprising:
a chip substrate on which the optical active device is mounted; and
a chip bonding bumper interposed between the chip substrate and the substrate,
wherein the optical active device is interposed between the chip substrate and the substrate. the optical active device being disposed on the optical grating.

4. The semiconductor opto-electronic integrated circuit of claim 1, wherein the optical active device absorbs or does not absorb an optical signal traveling through the optical waveguide by controlling an electrical potential between the first and second reflective wherein a non-absorbed optical signal is outputted to the optical waveguide through the optical grating.

5. The semiconductor opto-electronic integrated circuit of claim 1, wherein the optical active device is configured to modulate a phase of the selected optical signal and output a modulated optical signal to the optical waveguide through the optical grating.

6. (canceled)

7. The semiconductor opto-electronic integrated circuit of claim 1, wherein the first reflective layer, the optical active layer, and the second reflective layer are formed of a III-V compound semiconductor.

8. The semiconductor opto-electronic integrated circuit of claim 7, wherein one of the first and second reflective layers is doped with an n-type dopant and the other is doped with a p-type dopant.

9. The semiconductor opto-electronic integrated circuit of claim 7, wherein the optical active layer is formed of a multi quantum well layer.

10. The semiconductor opto-electronic integrated circuit of claim 7, wherein the optical active layer is in an intrinsic state.

11. The semiconductor opto-electronic integrated circuit of claim 1, wherein the semiconductor opto-electronic integrated circuit having a plurality of optical waveguides disposed on the substrate, a plurality of optical gratings are disposed on the optical waveguides, respectively, and a plurality of optical active devices disposed on the optical gratings, respectively,
wherein the semiconductor opto-electronic integrated circuit further comprises:
a demultiplexer including an input path and a plurality of output paths, each output path being connected to one of input terminals of the optical waveguides; and
a multiplexer including an output path and a plurality of input paths, each input path being connected to one of output terminals of the optical waveguides.

12. A method of forming a semiconductor opto-electronic integrated circuit, the method comprising:
forming an optical waveguide on a substrate, the optical waveguide having an optical grating, the optical waveguide extending along a first direction and having an input terminal and an output terminal, the optical waveguide providing an optical path along the first direction for optical signals traveling from the input terminal; providing a cladding layer between the optical waveguide and the substrate, the cladding layer being configured to contain the optical signals traveling between the input terminal and the output terminal within the optical waveguide;
providing an optical active device on the optical grating, the optical active device having an optical active layer provided between first and second reflective layers, the first reflective layer being disposed on the optical grating and having a lower reflectivity than the second reflective layer.
wherein the first reflective layer is configured to allow a selected optical signal to pass through the first reflective layer and into the optical active layer according to a control signal received by the optical active device,
wherein the optical active layer is configured to modulate the selected optical signal that has passed through the first reflective layer, and
wherein the second reflective layer is configured to reflect the optical signal modulated by the optical active layer to the optical waveguide and be transmitted to the output terminal of the optical waveguide.

13. The method of claim 12, wherein providing the optical active device on the optical grating comprises:
activating a lower surface of the optical active device;
activating an upper surface of the substrate including surfaces of the optical waveguide and the optical grating; and
bonding the activated lower surface of the optical active device with the activated upper surface of the substrate.

14. The method of claim 12, wherein providing the optical active device on the optical grating comprises:
mounting the optical active device on the optical grating; and
flip-chip bonding a chip substrate having the optical active device on the substrate using a chip bonding bumper.

15. (canceled)

16. The method of claim 12, wherein the first reflective layer, the optical active layer, and the second reflective layer are formed of a III-V compound semiconductor.

17. The method of claim 16, wherein one of the first and second reflective layers is doped with an n-type dopant and the other is doped with a p-type dopant.
